(19) United States
(12) Patent Application Publication
(10) Pub. No.: US 2008/0122741 A1
(43) Pub. Date: May 29, 2008

(54) PLASMA DISPLAY DEVICE AND DRIVING METHOD THEREOF

(75) Inventor: Seunghun Chae, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/941,294

(22) Filed: Nov. 16, 2007

(30) Foreign Application Priority Data
Nov. 27, 2006 (KR) 2006-117889

(51) Int. Cl. G09G 3/28

(52) U.S. Cl. 345/60

(57) ABSTRACT

A method of driving a plasma display device wherein one frame is divided into a plurality of sub-fields each including a reset period, an address period, and a sustain period, and a gray level is expressed by a combination of weight values of luminances of the sub-fields. The method includes changing a number of the sub-fields in one frame based on a cumulative operating time of the plasma display device; and changing a width, and/or a slope, and/or a number of a reset pulse supplied to a plasma display panel of the plasma display device in the reset period, and/or a scan pulse supplied to the plasma display panel in the address period, and/or a sustain pulse supplied to the plasma display panel in the sustain period when the number of the sub-fields in one frame is changed.

### CROSS-REFERENCE TO RELATED APPLICATIONS

This application claims the benefit of Korean Patent Application No. 2006-117889 filed on Nov. 27, 2006, in the Korean Intellectual Property Office, the disclosure of which is incorporated herein by reference in its entirety.

### BACKGROUND OF THE INVENTION

1. Field of the Invention

An aspect of the invention relates to a plasma display device and a driving method thereof, and more particularly to a plasma display device and a driving thereof that can generate a stable electric discharge and compensate for a reduction in luminance.

2. Description of the Related Art

Generally, a plasma display device is a display device using a plasma display panel (hereafter referred to as a “PDP”) for displaying text or an image using a plasma generated by a gas discharge.

The PDP is driven by dividing one frame into a plurality of sub-fields each having a respective weight value. A state of a discharge cell is initialized during a reset period in each of the sub-fields, light emitting cells and non-light emitting cells are selected during an address period in each of the sub-fields, and a sustain discharge is performed in light emitting cells during a sustain period in each of the sub-fields to actually display an image. Further, a gray level is displayed by a combination of weight values of luminances of the sub-fields emitted from the light emitting cells.

When the PDP has been operated for a long time, a protective layer, a phosphor, and the like inside the PDP deteriorate. Accordingly, the PDP suffers from a problem wherein a discharge characteristic, especially a luminance, is reduced in a PDP that has been operated for a long time compared to a PDP that has been operated for a short time.

### SUMMARY OF THE INVENTION

Accordingly, an aspect of the invention is to provide a plasma display device and a driving method thereof that can generate a stable discharge and compensate for a reduction in luminance.

According to an aspect of the invention, in a method of driving a plasma display device, one frame is divided into a plurality of sub-fields each including a reset period, an address period, and a sustain period, and a gray level is expressed by a combination of weight values of luminances of the sub-fields. The method includes changing a number of the sub-fields in one frame based on a cumulative operating time of the plasma display device; and changing a width, and/or a slope, and/or a number of a reset pulse supplied to a plasma display panel of the plasma display device in the reset period, and/or a scan pulse supplied to the plasma display panel in the address period, and/or a sustain pulse supplied to the plasma display panel in the sustain period when the number of the sub-fields in one frame is changed.

The changing of a number of the sub-fields in one frame may include checking whether the cumulative operating time of the plasma display device has exceeded a critical time; and reducing the number of the sub-fields in one frame when the cumulative operating time has exceeded the critical time to a number of sub-fields that is less than the number of the sub-fields in one frame when the cumulative operating time has not exceeded the critical time.

The changing of a width, and/or a slope, and/or a number may include changing a width, and/or a slope, and/or a number of the reset pulse supplied to the plasma display panel in the reset period in each of the reduced number of sub-fields.

The changing of a width, and/or a slope, and/or a number may include changing a width of the scan pulse supplied to the plasma display panel in the address period in each of the reduced number of sub-fields.

The changing of a width, and/or a slope, and/or a number may include changing a width, and/or a slope, and or a number of the sustain pulse supplied to the plasma display panel in the sustain period in each of the reduced number of sub-fields.

According to another aspect of the invention, a plasma display device includes a plasma display panel; a controller to divide one frame into a plurality of sub-fields each including a reset period, an address period, and a sustain period; and a driver to supply a reset pulse to the plasma display panel in the reset period, a scan pulse to the plasma display panel in the address period, and a sustain pulse to the plasma display panel in the sustain period. The controller changes a number of the sub-fields in one frame based on a cumulative operating time of the plasma display device, and changes a width, and/or a slope, and/or a number of the reset pulse, and/or the scan pulse, and/or the sustain pulse when the number of the sub-fields in one frame is reduced.

The controller may include a time checker to check whether the cumulative operating time of the plasma display device has exceeded a critical time; and a sub-field generator to reduce the number of the sub-fields in one frame when the cumulative operating time has exceeded the critical time to a number of sub-fields that is less than the number of sub-fields in one frame when the cumulative operating time has not exceeded the critical time.

The controller may further include a reset pulse controller to change a width, and/or a slope, and/or a number of the reset pulse supplied to the plasma display panel in the reset period in each of the reduced number of sub-fields.

The controller may further include a scan pulse controller to change a width of the scan pulse supplied to the plasma display panel in the address period in each of the reduced number of sub-fields.

The controller may further include a sustain number generator to change a number of the sustain pulse supplied to the plasma display panel in the sustain period in each of the reduced number of sub-fields.

The controller may further include a sustain number generator to determine a number of the sustain pulse to be supplied to the plasma display panel in each of the sub-fields; and a sustain pulse controller to change a width and/or a slope of the sustain pulse supplied to the plasma display panel in each of the reduced number of sub-fields.

According to another aspect of the invention, a method of driving a plasma display device that includes a plasma display panel includes dividing one frame into a plurality of sub-fields; changing a number of the sub-fields in one frame based on a cumulative operating time of the plasma display device; and changing a parameter of a pulse supplied to the plasma display panel in each of the changed number of sub-fields.

Additional aspects and/or advantages of the invention will be set forth in part in the description which follows and, in part, will be obvious from the description, or may be learned by practice of the invention.

### BRIEF DESCRIPTION OF THE DRAWINGS

The above and other aspects and advantages of the invention will be more apparent from the following description of embodiments of the invention, taken in conjunction with the accompanying drawings of which:

FIG. 1 is a block diagram of a plasma display device according to a first aspect of the invention;

FIG. 2 is a block diagram of a controller shown in FIG. 1 according to the first aspect of the invention;

FIG. 3 is a diagram of sub-fields of respective frames that are reduced in number after the plasma display device shown in FIG. 1 according to the first aspect of the invention has been operated for a long time;

FIGS. 4a and 4b are waveform diagrams of a reset pulse supplied in a reset period of respective sub-fields shown in FIG. 3 according to the first aspect of the invention;

FIG. 5 is a block diagram of a controller of a plasma display device according to a second aspect of the invention;

FIG. 6 is a waveform diagram of a scan pulse supplied in an address period of respective sub-fields of the plasma display device according to the second aspect of the invention;

FIG. 7 is a block diagram of a controller of a plasma display device according to a third aspect of the invention;

FIG. 8 is a waveform diagram of a sustain pulse supplied in a sustain period of respective sub-fields of the plasma display device according to the third aspect of the invention;

FIG. 9 is a block diagram of a controller of a plasma display device according to a fourth aspect of the invention;

FIG. 10 is a diagram showing total reset periods, total address periods, total sustain periods, and total idle periods in respective frames of the plasma display device according to the fourth aspect of the invention; and

FIG. 11 is a waveform diagram of a sustain pulse supplied in a sustain period of respective sub-fields of the plasma display device according to the fourth aspect of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below by referring to the figures.

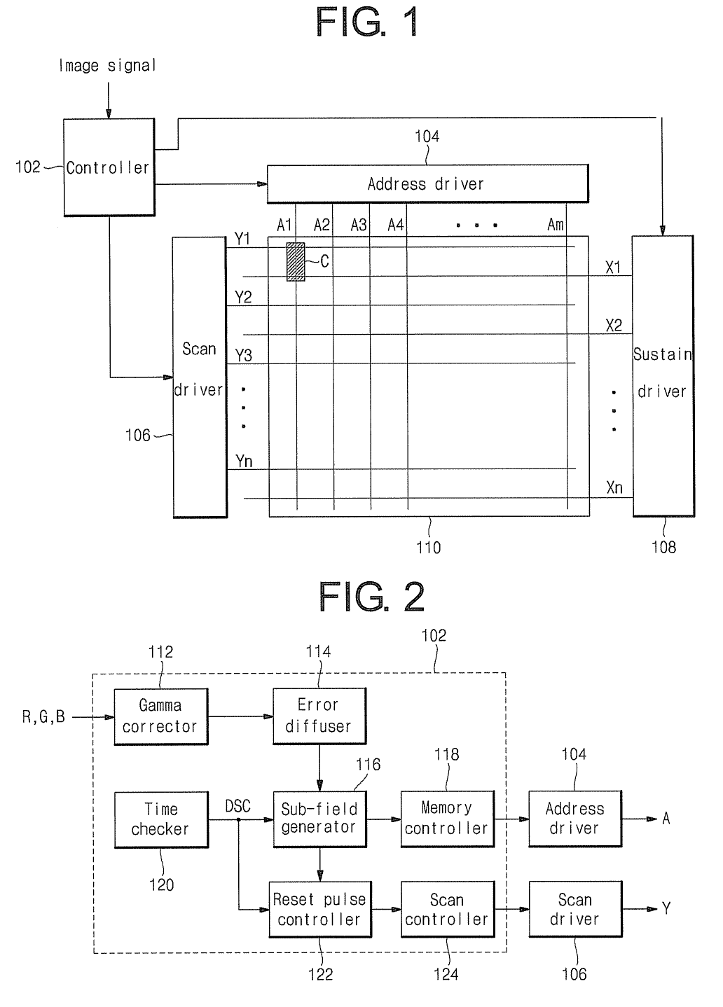

FIG. 1 is a block diagram of a plasma display device according to a first aspect of the invention.

Referring to FIG. 1, the plasma display device includes a plasma display panel (PDP or panel) 110 displaying an image, an address driver 104 supplying data to address electrodes (A1 to Am) of the PDP 110, a scan driver 106 driving scan electrodes (Y1 to Yn) of the PDP 110, a sustain driver 108 driving sustain electrodes (X1 to Xn) of the PDP 110, and a controller 102 controlling the drivers 104, 106, and 108.

The PDP 110 displays an image using a plurality of discharge cells (C) arranged in a matrix. The discharge cells (C) are at intersections of the address electrodes (A1 to Am) extending in the column direction, the scan electrodes (Y1 to Yn) extending in the row direction, and the sustain electrodes (X1 to Xn) extending in the row direction and forming pairs with the scan electrodes (Y1 to Yn). The address electrodes (A1 to Am) cross the scan electrodes (Y1 to Yn) and the sustain electrodes (X1 to Xn).

The address driver 104 supplies a data signal to select discharge cells to be displayed to the address electrodes (A) in response to an address control signal outputted from the controller 102.

The scan driver 106 applies driving voltages to the scan electrodes (Y1 to Yn) in response to a scan control signal outputted from the controller 102.

The sustain driver 108 applies driving voltages to the sustain electrodes (X1 to Xn) in response to a sustain control signal outputted from the controller 102.

The controller 102 divides one frame into a plurality of sub-fields each including a reset period, an address period, and a sustain period. Further, the controller 102 receives a vertical/horizontal synchronizing signal (not shown) and then generates the address control signal, the scan control signal, and the sustain control signal to control the drivers 104, 106, and 108. The control signals are supplied to the drivers 104, 106, and 108 so that the controller 102 controls the drivers 104, 106, and 108.

FIG. 2 is a block diagram of the controller 102 shown in FIG. 1 according to the first aspect of the invention.

The controller 102 of the plasma display device shown in FIG. 2 includes a gamma corrector 112, an error diffuser 114, a sub-field generator 116, a memory controller 118, a time checker 120, a reset pulse controller 122, and a scan controller 124.

The gamma corrector 112 processes an inputted image data (R, G and B) having a reverse nonlinear input/output characteristic to be image data (R, G and B) having a linear input/output characteristic.

The error diffuser 114 error-diffuses some bits of the image data (R, G and B), gamma-corrected by the gamma corrector 112, to adjacent discharge cells. The operation of the error diffuser 114 is known to those of ordinary skill in the art, and accordingly it will not be described in detail here.

The time checker 120 measures and accumulates a cumulative operating time of the plasma display device. The cumulative operating time may be measured by sensing a point of time when a power-on signal is supplied to a power supply (not shown), or a point of time when a sustain voltage is supplied to a driver of the PDP 110 or to the PDP 110, or by various other methods.

The time checker 120 supplies a deterioration sensing signal (DSC) to the sub-field generator 116 and the reset pulse controller 122 when the cumulative operating time accumulated from a first time the plasma display device was operated after being manufactured to the present time exceeds a critical time. In this case, the critical time, which is a time when a protection layer or a phosphor inside the PDP 110 begins to deteriorate, thereby causing a discharge characteristic of the PDP 110 to begin to deteriorate, may be determined by testing a pre-production sample of the plasma display device.

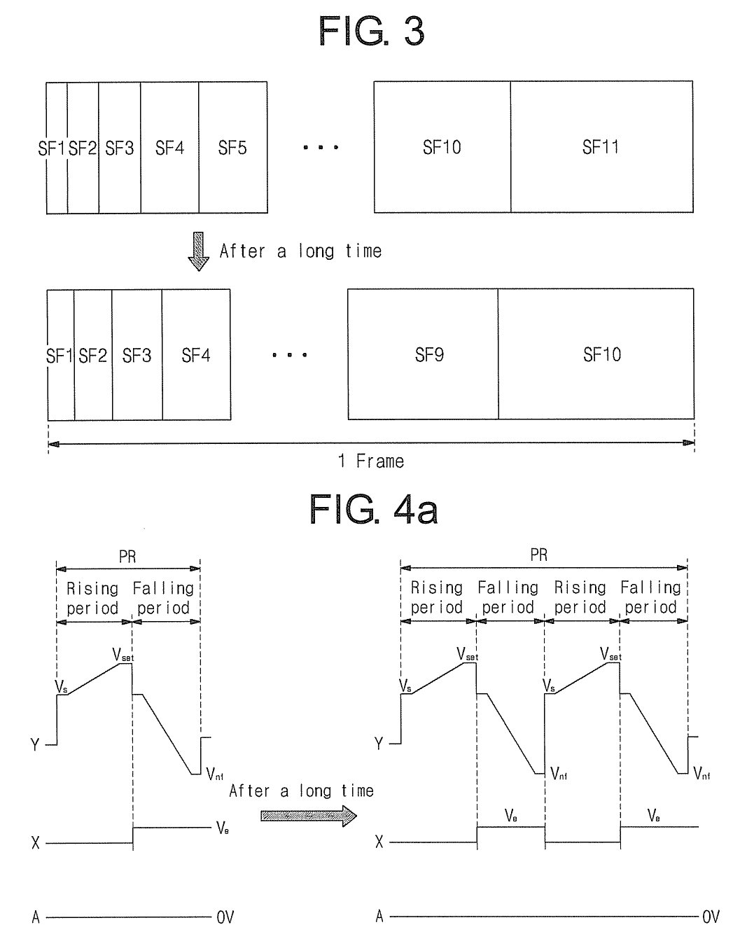

The sub-field generator 116 generates a number of sub-fields corresponding to a gray level of image data outputted from the error diffuser 114, and generates sub-field data corresponding to the number of sub-fields. Further, the sub-field generator 116 reduces the number of sub-fields corresponding to the gray level of the image data outputted from the error diffuser 114 in response to the DSC, and then generates sub-field data corresponding to the reduced number of sub-fields. For example, as shown in FIG. 3, the sub-field generator 116 generates 11 sub-fields (SF1 to SF11) before the DSC is inputted to the sub-field generator 116 from the time checker 120, and generates 10 sub-fields (SF1 to SF10) after the DSC is inputted to the sub-field generator 116 from the time checker 120 as a result of the plasma display device having been operated for a long time. In this case, it is necessary to reduce the number of sub-fields in a range in which there is no difference in gray level expression.

The memory controller 118 rearranges sub-field data generated from the sub-field generator 116 into address data for driving the PDP 110 and supplies the address data to the address driver 104. Specifically, the memory controller 118 stores the address data according to a plurality of sub-fields included in one frame in a frame memory (not shown), and supplies the address data, corresponding to all discharge cells according to the respective sub-fields, read from the frame memory to the address driver 104.

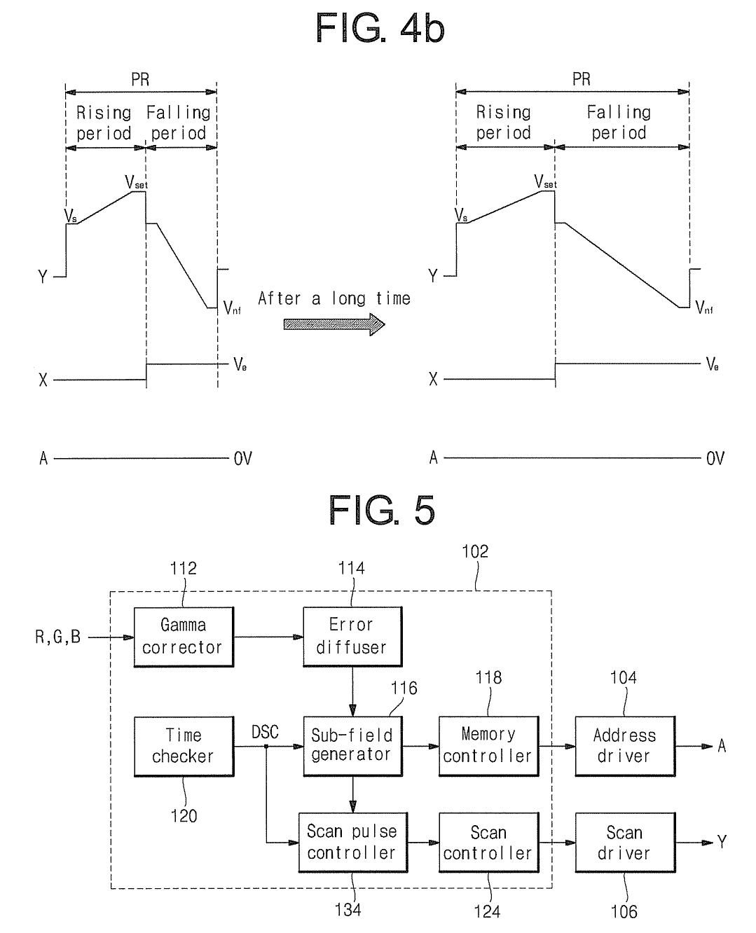

The reset pulse controller 122 controls a reset pulse supplied in each of the reduced number of sub-fields in response to the deterioration sensing signal (DSC). The operation of the reset controller 122 will be explained in detail with reference to FIGS. 4a and 4b.

As shown in FIG. 4a, the reset pulse controller 122 increases a number of reset pulses supplied in a reset period (PR) in each of the reduced number of sub-fields.

In other words, when the panel 110 has been operated for a short time, the reset period (PR) in sub-fields is divided into a rising period and a falling period. On the other hand, when the panel 110 has been operated for a long time, the reset period (PR) in each of the reduced number of sub-fields is divided into two rising periods and two falling periods. In the rising period of the reset period (PR), a reset pulse followed by a voltage that gradually increases from Vs to Vset is supplied to a scan electrode (Y) while a sustain electrode (X) is maintained at a reference voltage (which is 0V in FIG. 4a). In the falling period of the reset period (PR), a reset pulse followed by a voltage that gradually decreases from Vs to Vnf is supplied to a scan electrode (Y) while a voltage Ve is applied to the sustain electrode (X).

Thus, the number of reset pulses supplied in the reset periods (PR) of the panel 110 that has been operated for a long time is larger than the number of reset pulses supplied in the reset periods (PR) of the panel 110 that has been operated for a short time. When a relatively larger number of reset pulses are applied to the panel 110 that has been operated for a long time, in other words, to the panel 110 that has an unstable internal characteristic, as compared to the panel 110 that has been operated for a short time, a wall charge large enough to smoothly perform an address operation in a discharge cell will be generated as a result of generating a reset discharge at least two times in each of the reset periods (PR). However, it is understood that more than two reset pulses can be applied in each of the reset periods (PR) to the panel 110 that has been operated for a long time in other aspects of the invention.

As shown in FIG. 4b, the reset pulse controller 122 controls a rising slope of a reset pulse increasing from Vs to Vset and/or a falling slope of the reset pulse decreasing from Vs to Vnf. In other words, the rising and falling slopes of the reset pulse supplied in the reset period (PR) of the panel that has been operated for a long time are more gradual, i.e., less steep, than the reset pulse supplied in the reset period (PR) of the panel that has been operated for a short time. The reset pulse having the rising and falling slopes that are relatively less steep is supplied to the panel that has been operated for a long time, in other words to the panel that has an unstable internal characteristic, as compared to the panel that has been operated for a short time. Accordingly, a driving margin of the reset discharge is improved by relatively increasing a probability that a reset discharge will occur. However, it is understood that two or more reset pulses having the rising and falling slopes that are relatively less steep can be applied in each of the reset periods (PR) to the panel 110 that has been operated for a long time in other aspects of the invention.

The scan controller 124 generates a control signal corresponding to the number and/or the slopes of the reset pulses controlled by the reset pulse controller 122, and supplies the control signal to the scan driver 106 which generates the reset pulses in accordance with the control signal.

FIG. 5 is a block diagram of a controller of a plasma display device according to a second aspect of the invention.

The controller 102 of the plasma display device shown in FIG. 5 has the same configuration as the controller 102 shown in FIG. 2 according to the first aspect of the invention, except that the controller 102 in FIG. 5 includes a scan pulse controller 134 instead of the reset pulse controller 122 shown in FIG. 2. Accordingly, only the scan pulse controller 134 will be described in detail here.

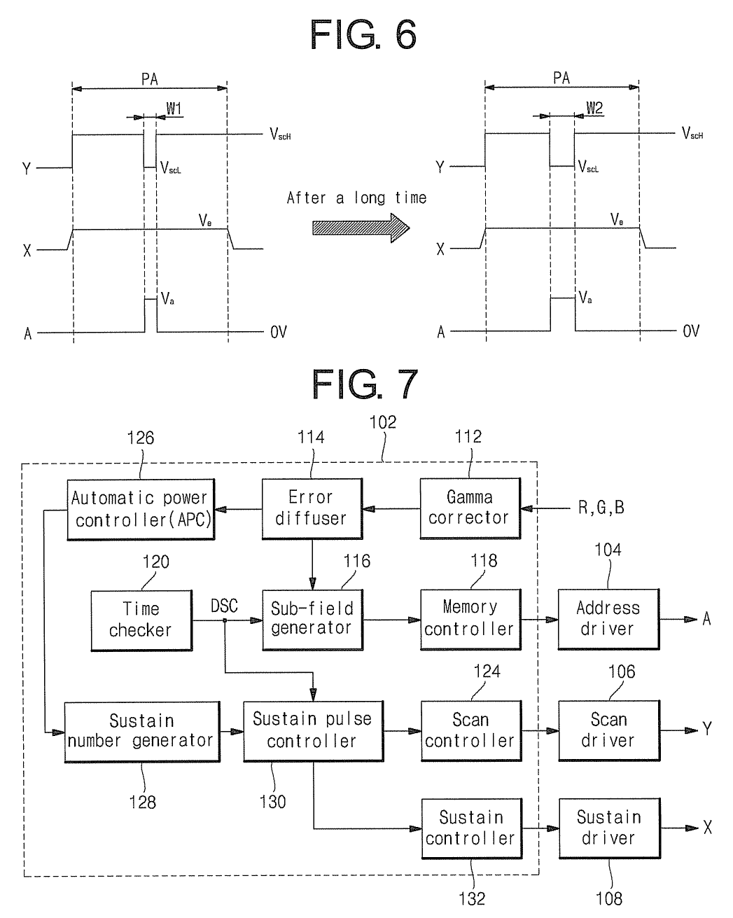

The scan pulse controller 134 controls a width of a scan pulse supplied in each of the reduced number of sub-fields in response to the deterioration sensing signal (DSC). The operation of the scan pulse controller will be explained in detail with reference to FIG. 6.

As shown in FIG. 6, the scan pulse controller 134 increases a width of a scan pulse supplied in an address period (PA) in each of the reduced number of sub-fields. In the address period (PA) for selecting a discharge cell to be turned on, a scan pulse having a voltage VscL and an address pulse having a voltage Va are respectively applied to a selected scan electrode (Y) and an address electrode (A) while a sustain electrode (X) is maintained at a voltage Ve. In this case, the address pulse has a width corresponding to the width of the scan pulse. That is, when the width of the scan pulse is increased by the scan pulse controller 134, the width of the address pulse is further increased to correspond to the width of the scan pulse. Further, the unselected scan electrodes (Y) (not shown) are biased at a voltage VscH higher than the voltage VscL, and a reference voltage is applied to the address electrodes (A) corresponding to discharge cells that are to be turned off (not shown). An address discharge is generated in a discharge cell to be turned on located at the intersection of the address electrode (A) to which the voltage Va is applied and the scan electrode (Y) to which the voltage VscL is applied.

In other words, a width (W2) of the scan pulse supplied to the panel 110 that has been operated for a long time is larger than a width (W1) of the scan pulse supplied to the panel 110 that has been operated for a short time. When a scan pulse having a relatively increased width is supplied to the panel 110 that has been operated for a long time, in other words, to the panel 110 that has an unstable internal characteristic, as compared to the panel 110 that has been operated for a short time, a probability of generating an address discharge relatively increases, thereby making it possible to generate a stable address discharge.

The scan controller 124 generates a control signal corresponding to the width of the scan pulse controlled by the scan pulse controller 134, and supplies the control signal to the scan driver 106 which generates the scan pulse in accordance with the control signal.

FIG. 7 is a block diagram of a controller of a plasma display device according to a third aspect of the invention.

The controller 102 of the plasma display device shown in FIG. 7 has the same configuration as the controller 102 shown in FIG. 2 according to the first aspect of the invention, except that the controller 102 shown in FIG. 7 includes an automatic power controller (APC) 126, a sustain number generator 128, a sustain pulse controller 130, and a sustain controller 132 instead of the reset pulse controller 122 shown in FIG. 2. Accordingly, only the APC 126, the sustain number generator 128, the sustain pulse controller 130, and the sustain controller 132 will be described in detail here.

The APC 126 detects a load factor of a displayed frame using image data outputted from the error diffuser 114, and calculates an APC level according to the detected load factor. The operation of the APC 126 is known to those of ordinary skill in the art, and accordingly it will not be described in detail here.

The sustain number generator 128 determines a number of sustain pulses to be supplied in each of the sub-fields based on the APC level calculated by the APC 126.

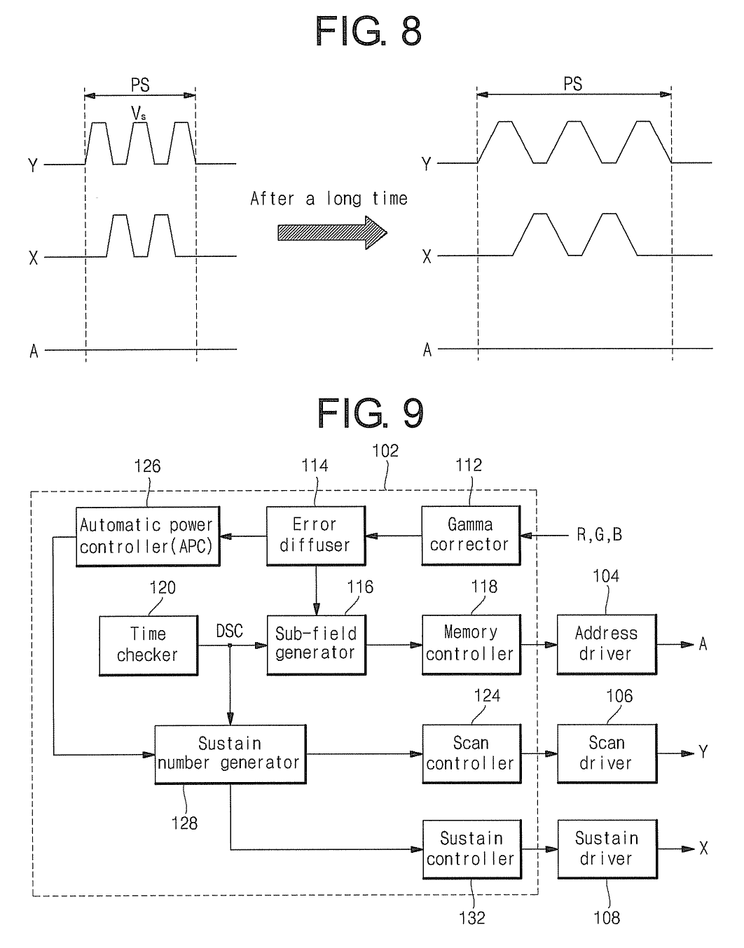

The sustain pulse controller 130 controls a width of a rising period, and/or a width of a maintaining period, and/or a width of a falling period of the sustain pulses supplied in each of the reduced number of sub-fields in response to the deterioration sensing signal (DSC). The operation of the sustain pulse controller 130 will be explained in detail with reference to FIG. 8.

As shown in FIG. 8, the sustain pulse controller 130 increases a width of a sustain pulse having a voltage Vs that is alternately supplied to a scan electrode (Y) and sustain electrode (X) in a sustain period (PS) of the reduced number of sub-fields. In other words, the width of the sustain pulse supplied to the panel 110 that has been operated for a long time is larger than the width of the sustain pulse supplied to the panel 110 that has been operated for a short time. When a sustain pulse having a relatively increased width is supplied to the panel 110 that has been operated for a long time, in other words, to the panel 110 that has an unstable internal characteristic, as compared to the panel 110 that has been operated for a short time, a probability of generating a sustain discharge relatively increases, thereby making it possible to generate a stable sustain discharge. If the width of the rising period of the sustain pulse is increased, a slope of a rising portion of the sustain pulse will be decreased. If the width of the falling period of the sustain pulse is increased, a slope of a falling portion of the sustain pulse will be decreased.

The scan controller 124 and the sustain controller 132 generate control signals corresponding to the width of the sustain pulse controlled by the sustain pulse controller 130, and supply the control signals to the scan driver 106 and the sustain driver 108 which generate the sustain pulse in accordance with the control signals.

FIG. 9 is a block diagram of a controller of a plasma display device according to a fourth aspect of the invention.

The controller 102 of the plasma display device shown in FIG. 9 has the same configuration as the controller 102 shown in FIG. 2 according to the first aspect of the invention, except that the controller 102 shown in FIG. 9 includes an automatic power controller (APC) 126, a sustain number generator 128, and a sustain controller 312 instead of the reset pulse controller 122 shown in FIG. 2. Accordingly, only the APC 126, the sustain number generator 128, and the sustain controller 132 will be described in detail here.

The APC 126 detects a load factor of a displayed frame using image data outputted from the error diffuser 114, and calculates an APC level according to the detected load factor. The operation of the APC 126 is known to those of ordinary skill in the art, and accordingly it will not be described in detail here.

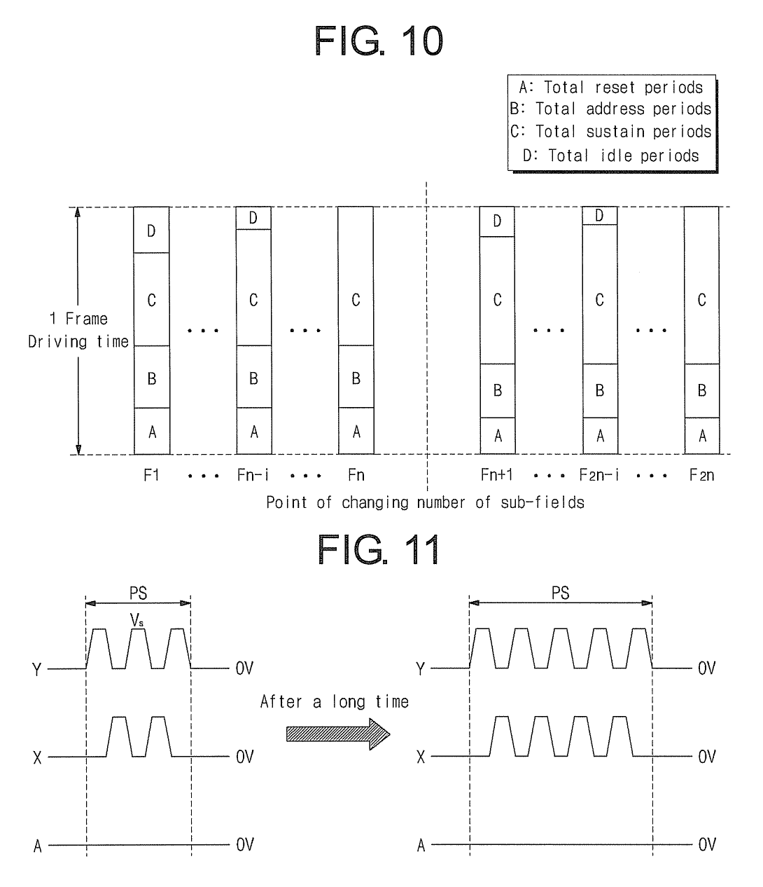

The sustain number generator 128 determines a number of sustain pulses to be supplied in each of the sub-fields based on the APC level calculated by the APC 126, and controls the number of sustain pulses supplied in each of the reduced number of sub-fields in response to the deterioration sensing signal (DSC). The operation of the sustain number generator 128 will be explained in detail with reference to FIGS. 10 and 11.

As shown in FIG. 10, when the panel 110 has been operated for a long time, the number of the sub-fields in one frame is decreased by the sub-field generator 116 in response to the DSC, so that a total number of reset periods, a total number of address periods, a total number of sustain periods, and a total number of idle periods in one frame are lower than in the panel 110 that has been operated for a short time. The extra time that is obtained by reducing the total number of reset periods, the total number of address periods, and the total number of idle periods in one frame by reducing the number of sub-fields in one frame is allocated to the sustain periods in the reduced number of sub-fields, preferably in proportion to the original time lengths of the sustain periods. Accordingly, when the panel 110 has been operated for a long time, the total time allocated to the sustain periods in one frame is longer than when the panel 110 has been operated for a short time, and the sustain periods in the reduced number of frames are relatively longer than corresponding sustain periods in the original number of sub-fields.

Accordingly, when the panel 110 has been operated for a long time, the number of sustain pulses supplied in a sustain period (PS) which is relatively lengthened increases as shown in FIG. 11 as compared to the panel 110 that has been operated for a short time. In other words, the number of sustain pulses supplied to the panel 110 that has been operated for a long time is higher than the number of sustain pulses supplied to the panel 110 that has been operated for a short time. When a relatively larger number of sustain pulses are supplied to the panel 110 that has been operated for a long time, in other words, to the panel 110 that has an unstable internal characteristic, as compared to the panel 110 that has been operated for a short time, as a result of allocating the extra time obtained by reducing the number of sub-fields in one frame to the sustain periods in the reduced number of sub-fields, the luminance of the panel 110 that has been operated for a long time is improved.

The scan controller 124 and the sustain controller 132 generate control signals corresponding to the number of the sustain pulses controlled by the sustain number generator 128, and supply the control signals to the scan driver 106 and the sustain driver 108 which generate the sustain pulses in accordance with the control signals.

As described above, a plasma display device according to aspects of the invention produces the following and/or other effects. When a plasma display panel has been operated for a long time, a number of sub-fields in one frame is reduced, and a reset pulse, and/or a scan pulse, and/or a sustain pulse is/are controlled in the reduced number of sub-fields, so that a reset discharge, and/or an address discharge, and/or a sustain discharge is/are stabilized or/and a luminance is improved.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of driving a plasma display device wherein one frame is divided into a plurality of sub-fields each comprising a reset period, an address period, and a sustain period, and a gray level is expressed by a combination of weight values of luminances of the sub-fields, the method comprising:
changing a number of the sub-fields in one frame based on a cumulative operating time of the plasma display device; and
changing a width, and/or a slope, and/or a number of a reset pulse supplied to a plasma display panel of the plasma display device in the reset period, and/or a scan pulse supplied to the plasma display panel in the address period, and/or a sustain pulse supplied to the plasma display panel in the sustain period when the number of the sub-fields in one frame is changed.

2. The method of claim 1, wherein the changing of a number of the sub-fields in one frame comprises:
checking whether the cumulative operating time of the plasma display device has exceeded a critical time; and
reducing the number of the sub-fields in one frame when the cumulative operating time has exceeded the critical time to a number of sub-fields that is less than the number of the sub-fields in one frame when the cumulative operating time has not exceeded the critical time.

3. The method of claim 2, wherein the changing of a width, and/or a slope, and/or a number comprises changing a width, and/or a slope, and/or a number of the reset pulse supplied to the plasma display panel in the reset period in each of the reduced number of sub-fields.

4. The method of claim 2, wherein the changing of a width, and/or a slope, and/or a number comprises changing a width of the scan pulse supplied to the plasma display panel in the address period in each of the reduced number of sub-fields.

5. The method of claim 2, wherein the changing of a width, and/or a slope, and/or a number comprises changing a width, and/or a slope, and/or a number of the sustain pulse supplied to the plasma display panel in the sustain period in each of the reduced number of sub-fields.

6. A plasma display device comprising:
a plasma display panel;
a controller to divide one frame into a plurality of sub-fields each comprising a reset period, an address period, and a sustain period; and
a driver to supply a reset pulse to the plasma display panel in the reset period, a scan pulse to the plasma display panel in the address period, and a sustain pulse to the plasma display panel in the sustain period;
wherein the controller changes a number of the sub-fields in one frame based on a cumulative operating time of the plasma display device, and changes a width, and/or a slope, and/or a number of the reset pulse, and/or the scan pulse, and/or the sustain pulse when the number of the sub-fields in one frame is changed.

7. The plasma display device of claim 6, wherein the controller comprises:
a time checker to check whether the cumulative operating time of the plasma display device has exceeded a critical time; and
a sub-field generator to reduce the number of the sub-fields in one frame when the cumulative operating time has exceeded the critical time to a number of sub-fields that is less the number of sub-fields in one frame when the cumulative operating time has not exceeded the critical time.

8. The plasma display device of claim 7, wherein the controller further comprises a reset pulse controller to change a width, and/or a slope, and/or a number of the reset pulse supplied to the plasma display panel in the reset period in each of the reduced number of sub-fields.

9. The plasma display device of claim 7, wherein the controller further comprises a scan pulse controller to change a width of the scan pulse supplied to the plasma display panel in the address period in each of the reduced number of sub-fields.

10. The plasma display device of claim 7, wherein the controller further comprises a sustain number generator to change a number of the sustain pulse supplied to the plasma display panel in the sustain period in each of the reduced number of sub-fields.

11. The plasma display device of claim 7, wherein the controller further comprises:
a sustain number generator to determine a number of the sustain pulse to be supplied to the plasma display panel in each of the sub-fields; and
a sustain pulse controller to change a width and/or a slope of the sustain pulse supplied to the plasma display panel in each of the reduced number of sub-fields.

12. A method of driving a plasma display device comprising a plasma display panel, the method comprising:
dividing one frame into a plurality of sub-fields;
changing a number of the sub-fields in one frame based on a cumulative operating time of the plasma display device; and
changing a parameter of a pulse supplied to the plasma display panel in each of the changed number of sub-fields.

13. The method of claim 12, wherein each of the sub-fields comprises a reset period; and
wherein the changing of a parameter comprises changing a parameter of a reset pulse supplied to the plasma display panel in the reset period in each of the changed number of sub-fields to achieve a stable reset discharge.

14. The method of claim 13, wherein the parameter is a width, and/or a slope, and/or a number of the reset pulse supplied to the plasma display panel in the reset period in each of the changed number of sub-fields.

15. The method of claim 12, wherein each of the sub-fields comprises an address period; and
wherein the changing of a parameter comprises changing a parameter of a scan pulse supplied to the plasma display panel in the address period in each of the changed number of sub-fields to achieve a stable address discharge.

16. The method of claim 15, wherein the parameter is a width of the scan pulse supplied to the plasma display panel in the address period in each of the changed number of sub-fields.

17. The method of claim 12, wherein each of the sub-fields comprises a sustain period; and
wherein the changing of a parameter comprises changing a parameter of a sustain pulse supplied to the plasma display panel in the sustain period in each of the changed number of sub-fields to achieve a stable sustain discharge and/or improve a luminance.

18. The method of claim 17, wherein the parameter is a width, and/or a slope, and/or a number of the sustain pulse supplied to the plasma display panel in the sustain period in each of the changed number of sub-fields.

19. The method of claim 12, wherein the changing of a number of the sub-fields in one frame comprises:
checking whether the cumulative operating time of the plasma display device has exceeded a critical time at which a discharge characteristic of the plasma display panel begins to deteriorate; and
reducing the number of the sub-fields in one frame when the cumulative operating time has exceeded the critical time to a number of sub-fields that is less than the number of the sub-fields in one frame when the cumulative operating time has not exceeded the critical time.

20. The method of claim 12, wherein the plasma display panel comprises a plurality of discharge cells;
wherein different luminance weights are respectively assigned to the sub-fields in one frame; and
wherein a gray level greater than zero is expressed by driving one of the discharge cells in one or more of the sub-fields in one frame selected in accordance with the gray level.
